(19) United States
(12) Patent Application Publication
(10) Pub. No.: US 2010/0207772 A1
(43) Pub. Date: Aug. 19, 2010

(54) REMOTE MONITORING SYSTEM FOR PLUG-IN VEHICLE

(75) Inventor: Tomokazu YAMAMOTO, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/706,170

(22) Filed: Feb. 16, 2010

(30) Foreign Application Priority Data
Feb. 16, 2009 (JP) 2009-33006

(51) Int. Cl. G08B 21/00

(52) U.S. Cl. 340/636.2

(57) ABSTRACT

A charging station has a power source and a station side connector. A plug-in vehicle has a battery, a vehicle side connector, a charge controller, a charge detecting device, a car-navigation system, and a WAN communication device. A remote monitoring system sends first information and/or second information to a terminal. The information relate to charging operation in the plug-in vehicle. The first information is an estimated charge completion time which is estimated based on a present charge amount and a required charge amount. The second information is charge completion information which is generated when the present charge amount reaches to the required charge amount.

### CROSS REFERENCE TO RELATED APPLICATION

This application is based on Japanese Patent Application No. 2009-33006 filed on Feb. 16, 2009, the contents of which are incorporated herein by reference in its entirety.

### FIELD OF THE INVENTION

The present invention relates to a remote monitoring system for a plug-in vehicle, which sends and notifies information relating to charging condition of a plug-in vehicle to a user.

### BACKGROUND OF THE INVENTION

In recent years, developments of the plug-in vehicles and a system for charging, i.e., recharging, the plug-in vehicles from an external power supply attract attentions. Here, the plug-in vehicle may include an electric automobile, a hybrid automobile with an electric motor and internal combustion engine, and other vehicles having rechargeable battery as a power source to move the vehicle. One typical usage of the plug-in vehicle would be as follows: the plug-in vehicle is driven for a certain distance, then, the plug-in vehicle is parked at a station such as a garage in a residence, and the plug-in vehicle is prepared for a next drive by charging a battery from an external power source during parking.

For example, the following patent document 1 discloses a charging system for an electric vehicle. In this system, a communication device is controlled in a waiting mode in which both receiving and sending are always possible, when a charging device starts charging, and a drive start switch is turned off. In addition, in this system, the communication device send out charge related information indicative of charge condition, such as a charge ratio to a full condition, time necessary for the full charge, and completion of charge.

Patent document 1: JP2004-48900A

### SUMMARY OF THE INVENTION

Considering usage of vehicles, usually, a user uses a vehicle while having a specific destination. In such a case, it is sufficient if the battery is charged with a certain amount of charge which is just necessary for a trip planned. For example, if it is required to drive the plug-in vehicle only by the electric motor by the electric energy charged in the battery, in order to drive one way trip to the destination or to drive a round trip to the destination, it is enough if the battery is charged with an amount of charge which just enables the plug-in vehicle to go one way trip or a round trip. However, in the conventional charging system for an electric vehicle, it is not considered to charge a battery with just a necessary amount. For example, in a case that a battery is charged up to an amount just for driving a certain distance, such as one way trip or a round trip to the destination, there is no technology to inform a completion of charging or time necessary for charging to a user.

It is an object of the present invention to provide useful charging information related to a charge of the plug-in vehicle to a user. It is another object of the present invention to provide a remote monitoring system for a plug-in vehicle which can enrich notifying applications to a user when charging a battery from an external power source.

In a first aspect of the present invention, a remote monitoring system for a plug-in vehicle is provided. The plug-in vehicle remote monitoring system includes sends information relating to charging operation in the plug-in vehicle to a terminal. The system comprises a detecting module, a calculating module, and an informing module. The detecting module detects a present charge amount in a battery of the plug-in vehicle. The calculating module calculates a required charge amount which is necessary for a trip planned for the plug-in vehicle. The informing module generates charge information relating to completion of charging based on the present charge amount detected by the detecting module and the required charge amount calculated by the calculating module, and sends the charge information to the terminal via a communication system. The charge information may be a charge completion information and/or an estimated time. The charge completion information can be obtained when the present charge amount reaches to the required charge amount. The estimated time can be obtained by estimating a time necessary to charge the battery to the required charge amount taking the present charge amount into consideration.

The calculating and informing modules in the present invention may be provided on any component such as the plug-in vehicle, the charging station, or a remote component such as an information center for managing the location of the plug-in vehicle. The modules may be provided on one component or on a plurality of components in a distributed manner. In such a distributed configuration, the components are connected with each other via appropriate communication system such as a power line communication system between the plug-in vehicle and the charging station and/or a network communication system between the charging station and the remote information center.

In addition, the information module may includes a network communication device mounted on the plug-in vehicle, a network communication device mounted on the charging station, which establishes connection to the network to which the terminal is connected and transmits the charge information. Preferably, the terminal is a portable device owned by a user of the plug-in vehicle or the charging station. For example, the terminal may be a mobile phone, a handheld information terminal, or a portable computer.

The modules may include section which manages the battery and a detecting device for detecting the present charge amount, and section which manages charging operation based on information retrieved from other module.

The module may include section which transmits and receives data among components in the system, such as a car-navigation system and a WAN communication device.

The modules may be provided in the same computer or the same control device. In addition, the modules may be provided in an electronic control unit, such as an electronic control unit having a primary purpose for the plug-in vehicle other than a battery related purpose. In addition, the modules may be provided in an electronic control unit that controls a charging voltage and/or a charging current to the battery.

The plug-in vehicle may be an electric vehicle having an electric motor or a hybrid vehicle having both an electric motor and an internal combustion engine. The charging station may be a place having a power source, such as a power outlet from a commercial power supplier or a power generator. For example, the charging station may be provided in a house or an office building. The power source is not limited to one having certain voltage. For example, the power source may be a commercial power with 100V or 200V in rated voltage, and 50 Hz or 60 Hz in frequency. In addition, a destination of the planned trip may be another charging station which is placed to charge the plug-in vehicle from the power source.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a block diagram showing a remote monitoring system for a plug-in vehicle according to a first embodiment of the present invention;

FIG. 2 is a flow chart showing a cycle of operation of the remote monitoring system for a plug-in vehicle according to the first embodiment of the present invention;

FIG. 3 is a block diagram showing a remote monitoring system for a plug-in vehicle according to a second embodiment of the present invention;

FIG. 4 is a flow chart showing a cycle of operation of the remote monitoring system for a plug-in vehicle according to the second embodiment of the present invention;

FIG. 5 is a block diagram showing a remote monitoring system for a plug-in vehicle according to a third embodiment of the present invention;

FIG. 6 is a flow chart showing a cycle of operation of the remote monitoring system for a plug-in vehicle according to the third embodiment of the present invention;

FIG. 7 is a block diagram showing a remote monitoring system for a plug-in vehicle according to a fourth embodiment of the present invention;

FIG. 8 is a flow chart showing a cycle of operation of the remote monitoring system for a plug-in vehicle according to the fourth embodiment of the present invention;

FIG. 9 is a block diagram showing a remote monitoring system for a plug-in vehicle according to a fifth embodiment of the present invention; and

FIG. 10 is a flow chart showing a cycle of operation of the remote monitoring system for a plug-in vehicle according to the fifth embodiment of the present invention.

### DETAILED DESCRIPTION OF THE PREFERRED EMBODIMENTS

A plurality of preferred embodiments of management system for charging a plug-in vehicle according to the present invention are described by referring to the attached drawings.

### First Embodiment

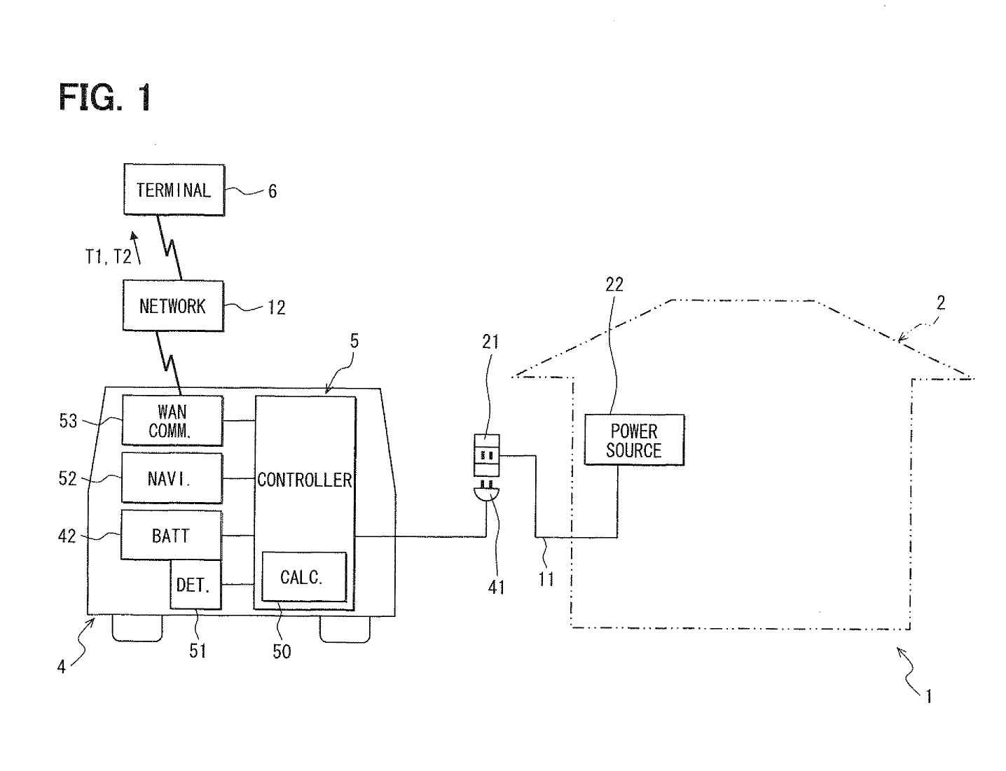

FIG. 1 shows a block diagram of a plug-in vehicle charging system including a remote monitoring system 1 for the plug-in vehicle 4 according to a first embodiment. The charging system enables charge to the plug-in vehicle 4 through a power line 11 from a power source 22 in a charging station 2. The power source 22 is an external power source connected to a commercial electric power supplier. The charging system is constructed to inform charging condition to a user of the plug-in vehicle 4.

The charging station 2 includes the power source 22 and a station side connector 21 connected to the power source 22. The plug-in vehicle 4 includes a vehicle side connector 41 which is able to be connected to the station side connector 21, and a battery 42 which is rechargeable from the power source 22 via the vehicle side connector 41. The plug-in vehicle 4 includes a charge controller 5 which manages charging operation to the battery 42, and a charge amount detecting device 51 which detects the charge amount charged in the battery 42. The plug-in vehicle 4 includes a car-navigation system 52 which receives input of a destination and calculates a route to the destination. The plug-in vehicle 4 further includes a WAN communication device 53 which is connectable with the communication network 12 and is capable of establishing data communication. The remote monitoring system 1 includes a calculating module 50 which calculates a required charge amount necessary for a one way trip to the destination from the charging station or the required charge amount necessary for a round trip to the destination from the charging station. In this embodiment, the calculating module 50 is a vehicle calculating module 50 which is provided in the charge controller 5 on the plug-in vehicle 4. The calculating module 50 calculates the required charge mount for the battery 42 necessary to reach to the destination from the charging station 2 or the required charge amount for the battery 42 necessary to reach to the destination and return to the charging station 2 again.

The charging system is constructed to perform charging operation of the battery 42 from the power source 22 when the station side connector 21 and the vehicle side connector 41 are connected. The remote monitoring system 1 is constructed to calculate and generate an estimated time T1 as charge information when performing the charging operation. The estimated time T1 is estimated as a time which is considered necessary to charge the battery 42 to the required charge amount Ctar by taking the present charge amount Cdet detected by the charge amount detecting device 51 into consideration.

The remote monitoring system 1 is constructed to send the estimated time T1 to the terminal 6 via the WAN communication device 53 and the communication network 12. The terminal 6 is a portable device owned by the user of the plug-in vehicle. The charge controller 5 calculates and sends the estimated time T1. The remote monitoring system 1 is constructed to generate charge completion information T2 as charge information when performing the charging operation. The charge completion information T2 is generated in response to a time when the present charge amount Cdet detected by the charge amount detecting device 51 reaches to the required charge amount Ctar, in the charging operation. The remote monitoring system 1 is constructed to send the charge completion information T2 to the terminal 6 via the WAN communication device 53 and the communication network 12. The charge controller 5 calculates and sends the charge completion information T2. Therefore, the charge controller 5 functions as an informing module.

As shown in FIG. 1, the charge controller 5 is provided as a part of a control device such as an electronic control unit on the plug-in vehicle 4. The charge controller 5 includes sections which perform functions for managing components such as the battery 42 and the charge amount detecting device 51 when charging the battery 42. The charge controller 5 includes sections which perform functions for transmitting and receiving data among components in the system, such as the car-navigation system 52 and the WAN communication device 53. The calculating module 50 is provided in the charge controller 5. The battery 42 supplies electric energy to a drive motor of the plug-in vehicle 4. The charge amount detecting device 51 detects a present charge amount Cdet charged in the battery 42 and sends signal indicative of detected charge amount to the charge controller 5. The car-navigation system 52 displays information such as a current position, a travel route to the destination, etc. on a display screen to show those information to a driver at the time of operation of the vehicle. The WAN communication device 53 connects the charge controller 5 to the communication network 12, such as the Internet.

The remote monitoring system 1 uses the car-navigation system 52 as an input device for inputting and setting a planned trip which can be defined by a destination, a route and a departure time. The remote monitoring system 1 informs the estimated time T1 which is estimated necessary to charge the battery 42 to a certain charge amount which is at least necessary for a one way trip or a round trip to the destination to the user of the plug-in vehicle 4. The charging system may be constructed to charge the battery 42 to only the certain charge amount which is at least necessary for a one way trip or a round trip to the destination. The remote monitoring system 1 informs that the battery 42 is charged with the certain charge amount which is at least necessary for a one way trip or a round trip to the destination to the user of the plug-in vehicle 4.

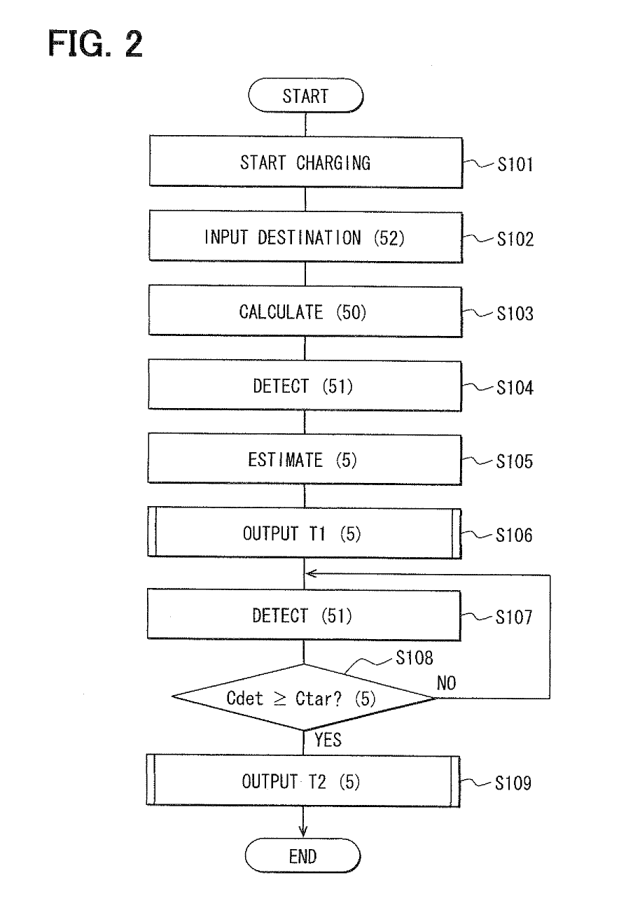

FIG. 2 is a flowchart showing operation of the plug-in vehicle remote monitoring system 1. First, the user of the plug-in vehicle 4 parks the plug-in vehicle 4 at the charging station 2. Then, the user connects the vehicle side connector 41 and the station side connector 21. In response to the connection of the connectors 21 and 41, the charging operation to the battery 42 from the power source 22 is initiated and performed under a control of the charge controller 5. This step is shown in a step S101.

The user inputs a destination to the ear-navigation system 52 before or after starting the charging operation. Then, the system retrieves the information including the destination from the car-navigation system 52. This step is shown in a step S102. In a step S103, the calculating module 50 calculates the required charge amount Ctar. The vehicle calculating module 50 retrieves the information about the destination from the car-navigation system 52, and calculates the required charge amount Ctar. The required charge amount Ctar is a charge amount necessary for a one way trip to the destination from the charging station or for a round trip to the destination from the charging station.

In a step S103, the calculating module 50 calculates the required charge amount Ctar by taking characteristics of the plug-in vehicle 4, such as power consumption into consideration. The vehicle calculating module 50 calculates the required charge amount Ctar based on information including a route from the charging station 2 to the destination, a road inclination from the charging station 2 to the destination, a departure time from the charging station 2 to the destination, and traffic information stored in the car-navigation system 52.

In a step S104, the charge controller 5 detects the present charge amount in the battery 42 by the charge amount detecting device 51. The present charge amount in the battery 42 is monitored by the charge controller 5 during the charging operation to the battery 42 from the power source 22. In a step S105, the charge controller 5 estimates the estimated time T1 based on a difference between the required charge amount Ctar and the present charge amount Cdet detected by the charge amount detecting device 51. The estimated time T1 is estimated necessary to charge the battery 42 to the required charge amount Ctar. The estimated time T1 can be calculated by taking several information into consideration. For example, the estimated time T1 may be calculated based on a charge current, a charge voltage, and a capacity of a battery charger circuit of the battery 42.

In a step S106, the charge controller 5 sends the estimated time T1 to the terminal 6 via the WAN communication device 53 and the communication network 12.

Thereby, the user of the plug-in vehicle 4 can know how long does it take to charge the battery 42 to the required charge amount Ctar which is necessary for a one way trip or a round trip to the destination by the plug-in vehicle 4, at a time of starting the charging operation.

In a step S107, the charge controller 5 monitors the present charge amount Cdet detected by the charge amount detecting device 51, during the charging operation is performed. In a step S108, the charge controller 5 determines whether the detected charge amount Cdet detected by the charge amount detecting device 51 reaches to the required charge amount Ctar calculated by the calculating module 50 or not. The charge controller 5 compares the detected charge amount Cdet and the required charge amount Ctar. If an expression Cdet>=Ctar is satisfied, the routine proceeds to a step S109. If the present charge amount Cdet reaches to the required charge amount Ctar, the charge controller 5 proceeds the routine to the step S109. If the present charge amount Cdet does not reach to the required charge amount Ctar, the charge controller 5 returns the routine to the step S107. In the step S109, the charge controller 5 sends the charge completion information T2 to the terminal 6 via the WAN communication device 53 and the communication network. The charge complete information may be a message to notify a completion of charging to the required charge amount Ctar.

Thereby, the system 1 can inform the user when the battery is charged with at least the required charge amount Ctar. Therefore, the user can be promptly informed in an early stage. According to the plug-in vehicle remote monitoring system 1 in this embodiment, it is possible to enrich notifying applications to the user.

### Second Embodiment

In the following description and drawings, the same reference numbers and symbols are given to components and parts which are the same or similar to that already described in the preceding embodiments. The preceding description may be referenced for the components and parts denoted by the same reference numbers and symbols. Hereinafter, differences from the preceding embodiments are mainly explained. Other configurations are similar to or the same as that of the above-mentioned embodiments, therefore, it is possible to achieve similar or the same functions and advantages as described in the above-mentioned embodiment.

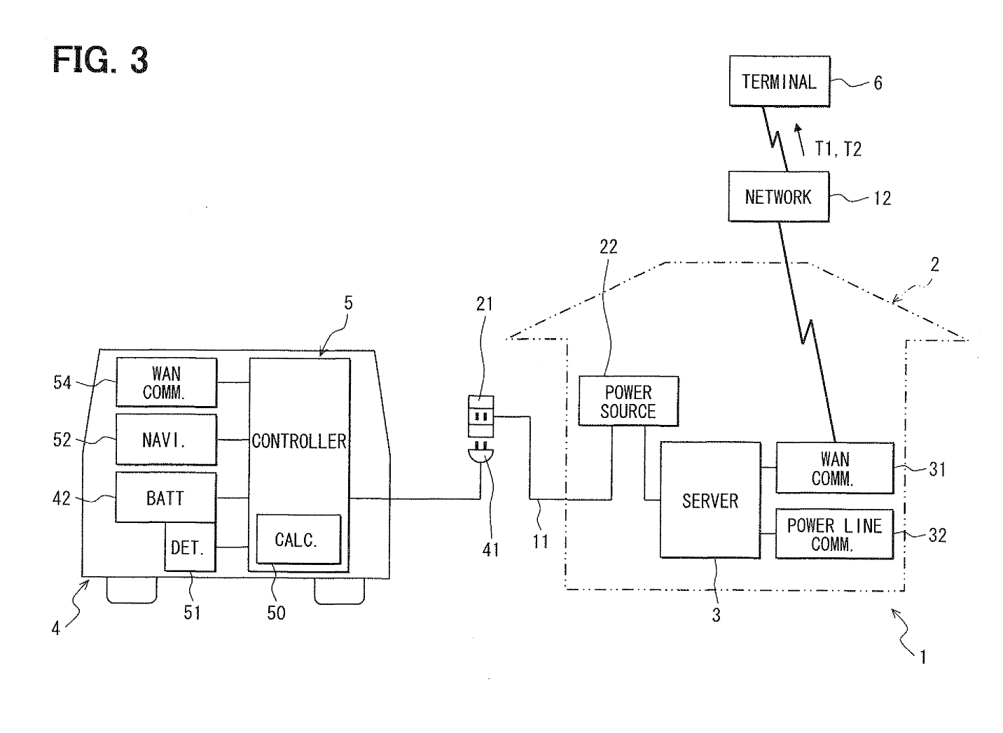

FIG. 3 shows a block diagram of the second embodiment. The plug-in vehicle remote monitoring system 1 includes components for providing a power line communication between the charging station 2 and the plug-in vehicle 4. The system 1 is constructed to send the estimated time T1 and the charge completion information T2 to the terminal 6 via the power line communication.

The charging station 2 includes a station side power line communication device 32 which performs the power line communication with a component on the plug-in vehicle 4. The charging station 2 further includes a network communication device 31 connectable with the communication network 12 and a server computer 3 connected with the network communication device 31 and the station side power line communication device 32. The plug-in vehicle 4 includes the vehicle side power line communication device 54 which performs the power line communication with the station side power line communication device 32.

The charge controller 5 is constructed to calculate and generate the estimated time T1. The charge controller 5 is constructed to send the estimated time T1 to the server computer 3 via the power line communication. The server computer 3 is constructed to relay and send the estimated time T1 to the terminal 6 via the WAN communication device 31 and the communication network 12.

The charge controller 5 is constructed to generate a signal in response to a time when the present charge amount Cdet reaches to the required charge amount Ctar. The charge controller 5 is constructed to send the signal to the server computer 3 via the power line communication. The server computer 3 is constructed to relay and send the charge completion information T2 to the terminal 6 via the WAN communication device 31 and the communication network 12.

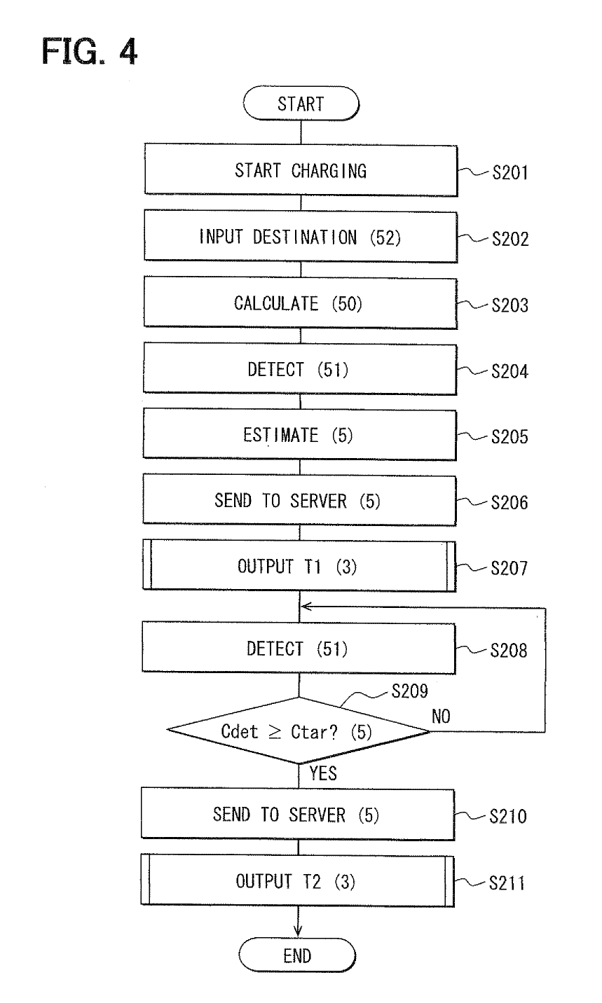

FIG. 4 is a flowchart showing operation of the plug-in vehicle remote monitoring system 1. Steps S201-S205 are the same as the steps S101-105. Steps S208 and S209 are the same as the steps S107 and S108, respectively. However, in this embodiment, the power line communication between the station side power line communication device 32 and the vehicle side power line communication device 54 becomes possible when the vehicle side connector 41 and the station side connector 21 are connected.

In a step S206, the charge controller 5 sends the estimated time T1 to the server computer 3 by using the power line communication between the station side power line communication device 32 and the vehicle side power line communication device 54. Then, in a step S207 the server computer 3 sends the estimated time T1 to the terminal 6 via the WAN communication device 31 and the communication network 12.

If the present charge amount Cdet reaches to the required charge amount Ctar, the charge controller 5 proceeds the routine to the step S210. In the step S210, the charge controller 5 sends a signal to the server computer 3 via the power line communication. Therefore, the charge controller 5 sends the signal to the server computer 3 when the present charge amount Cdet reaches to the required charge amount Ctar. In a step S211, in response to the signal from the charge controller 5, the server computer 3 sends the charge completion information T2 to the terminal 6 via the WAN communication device 31 and the communication network 12.

According to the plug-in vehicle remote monitoring system 1 in this embodiment, it is possible to enrich notifying applications to the user.

In this embodiment, the server computer 3 includes a part of the informing module. The charge controller 5 on the plug-in vehicle 4 contains a part of the informing module. It is possible to reduce processing load on the components on the plug-in vehicle 4. In addition, the required charge amount Ctar can be calculated by reflecting several factors available in the server computer 3.

### Third Embodiment

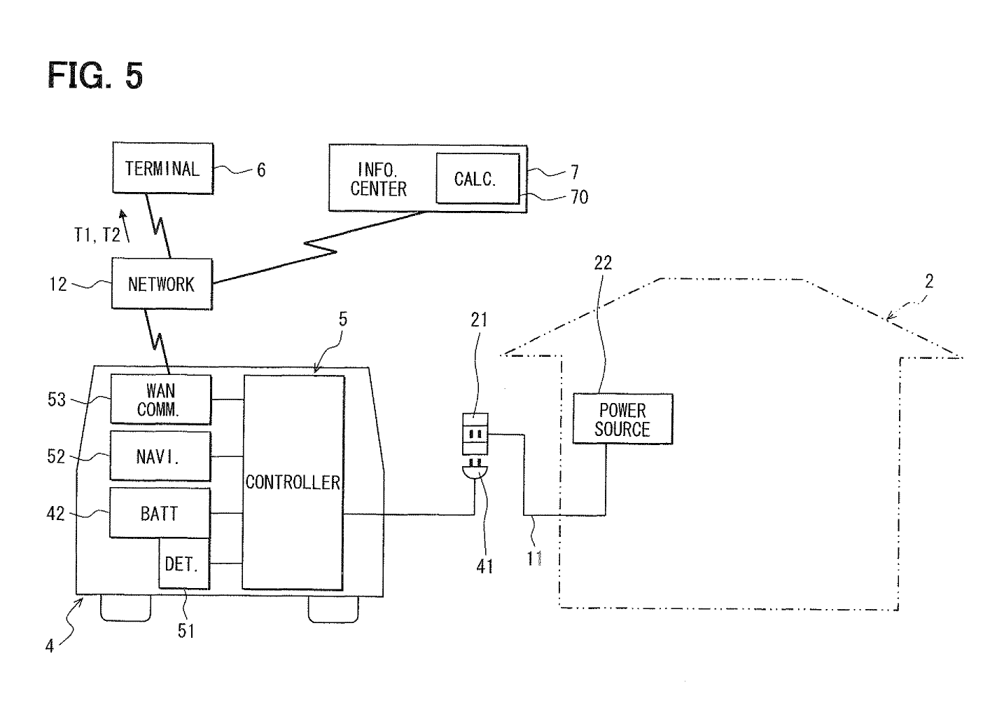

FIG. 5 shows a block diagram of the third embodiment.

The plug-in vehicle remote monitoring system 1 includes components for establishing communication with an external information center, such as an information center 7 which monitors and manages location and usage of the plug-in vehicle 4 in a real time fashion. The system 1 utilizes the information center 7 as a part of the system 1. In this embodiment, the system 1 uses the information center 7 to calculate the required charge amount. The system 1 is constructed to send the estimated time T1 and the charge completion information T2 to the terminal 6.

The information center 7 includes a remote module 70 which calculates the required charge amount Ctar. The car-navigation system 52 is used as an input device which receives a destination and a departure time. The user inputs the destination and the departure time to the car-navigation system 52. Information relating to driving of the plug-in vehicle 4 is monitored and managed by the information center 7 based on probe information. For example, the information center 7 monitors a location and a driving speed of the plug-in vehicle 4.

The remote module 70 on the information center 7 retrieves information including the destination and the departure time from the car-navigation system 52 via the WAN communication device 53 and the communication network 12. The remote module 70 calculates the required charge amount Ctar necessary for a one way trip to the destination from the charging station 2 or the required charge amount Ctar necessary for a round trip to the destination from the charging station 2. The required charge amount Ctar is calculated based on the retrieved information and information including route information and/or traffic information stored in the information center 7. The remote module 70 calculates the required charge amount Ctar during performing the charging operation to the battery 42 by connecting the station side connector 21 and the vehicle side connector 41. Then, the remote module 70 sends the required charge amount Ctar to the charge controller 5 via the WAN communication device 53 and the communication network 12. The charge controller 5 calculates and generates the estimated time T1. The estimated time T1 is estimated as a time which is considered necessary to charge the battery 42 to the required charge amount Ctar by taking the present charge amount Cdet detected by the charge amount detecting device 51 into consideration. The remote monitoring system 1 is constructed so that the charge controller 5 sends the estimated time T1 to the terminal 6 via the WAN communication device 53 and the communication network 12.

The charge controller 5 generates charge completion information in response to a time when the present charge amount Cdet reaches to the required charge amount Ctar, and sends the charge completion information T2 to the terminal 6 via the WAN communication device 53 and the communication network 12.

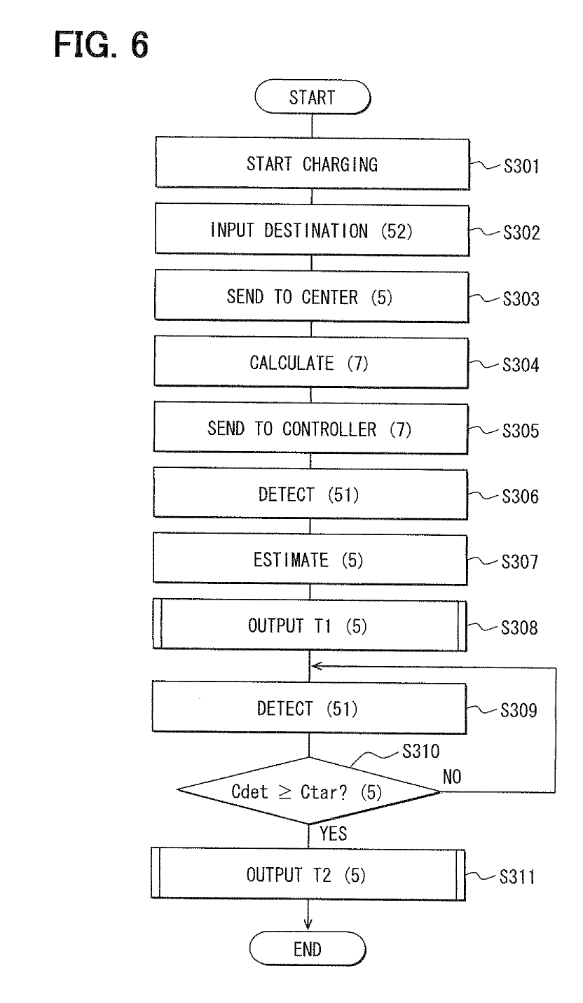

FIG. 6 is a flowchart showing operation of the plug-in vehicle remote monitoring system 1. In FIG. 6, steps S301, S302, and S306-S311 are the same as the steps S101, S102, and S104-S109, respectively. In a step S303, the information about the destination and the departure time inputted from the car-navigation system 52 is transmitted to the information center 7 by the WAN communication device 53 via the communication network 12. In a step S304, the remote module 70 on the information center 7 calculates the required charge amount Ctar. Then, in a step S305 the remote module 70 sends the required charge amount Ctar to the charge controller 5 via the communication network 12. In the step S304, the remote module 70 may calculate the required charge amount Ctar by taking characteristics of the plug-in vehicle 4, such as power consumption into consideration.

As described above, according to the embodiment, it is possible to send the estimated time T1 and the charge completion information T2 to the terminal 6. In this embodiment, the information center 7 includes the calculating module. The charge controller 5 on the plug-in vehicle 4 contains the informing module. It is possible to reduce processing load on the components on the plug-in vehicle 4. In addition, the required charge amount Ctar can be calculated by reflecting several factors which may affect consumption of the battery 42, such as traffic information and latest updated information about the route to the destination.

### Fourth Embodiment

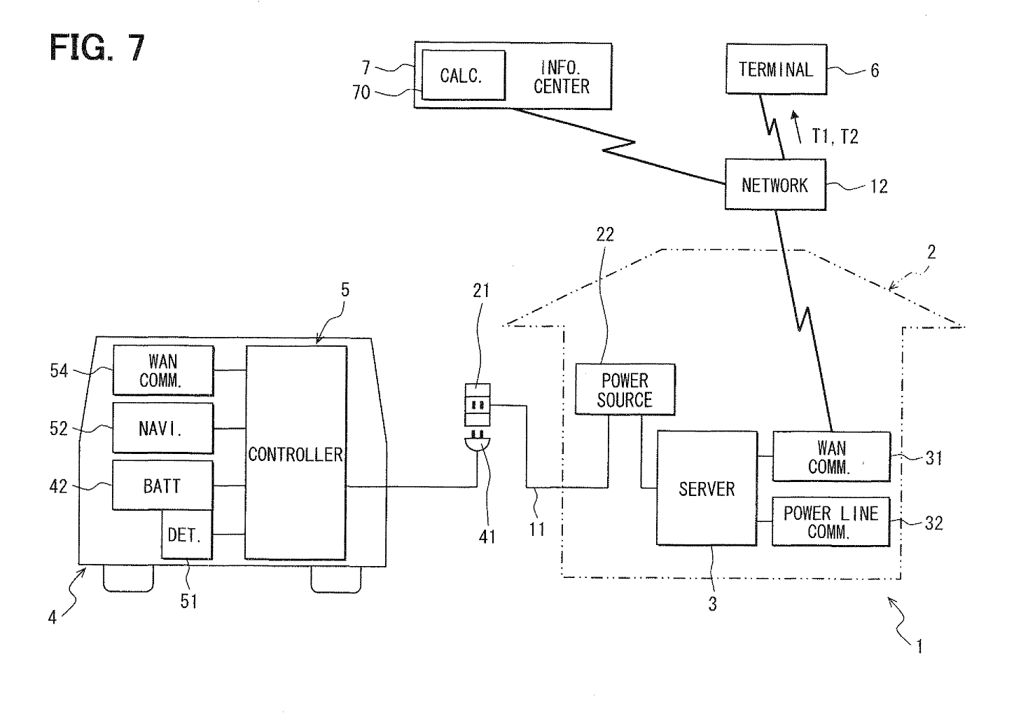

FIG. 7 shows a block diagram of the fourth embodiment.

The plug-in vehicle remote monitoring system 1 includes components for establishing communication with an external information center 7. In addition, the system 1 includes components for establishing a power line communication through a power line 11 between the plug-in vehicle 4 and the charging station 2. The power line communication provides a local data communication between the plug-in vehicle 4 and the charging station 2. The system 1 distributes some modules in the charging station 2. The system 1 is constructed to send the estimated time T1 and the charge completion information T2 to the terminal 6 through a server 3 on the charging station 2.

The charging station 2 includes a station side power line communication device 32, a network communication device 31, and a server computer 3. The plug-in vehicle 4 includes a vehicle side power line communication device 54. The station side power line communication device 32 and the vehicle side power line communication device 54 establish the power line communication during performing the charging operation by connecting the station side connector 21 and the vehicle side connector 41.

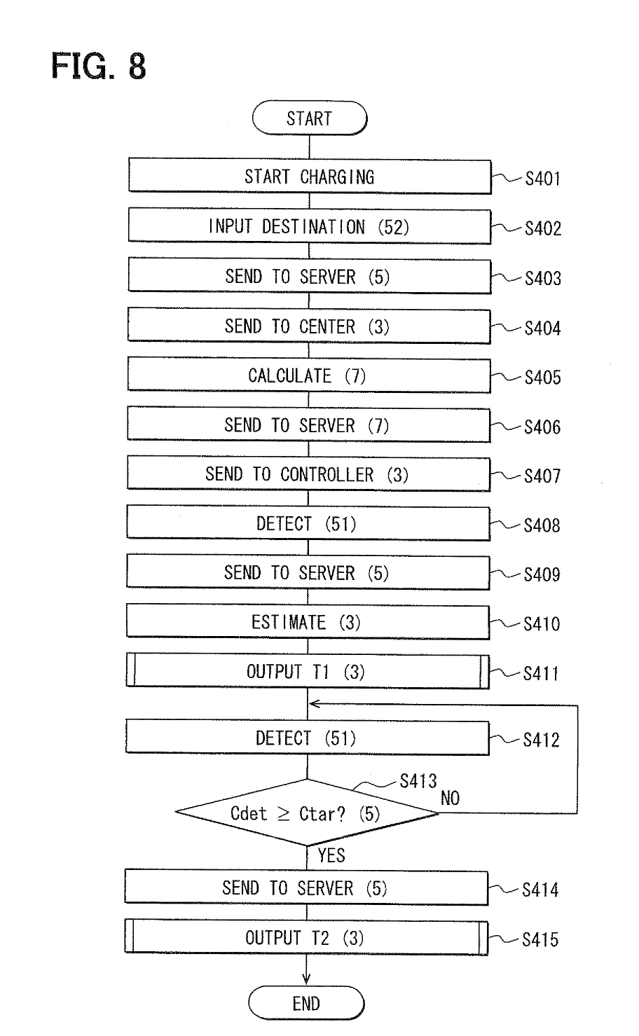

FIG. 8 is a flowchart showing operation of the plug-in vehicle remote monitoring system 1. Steps S401 and S402 are the same as the steps S101 and S102. In a step S403, the information about the destination and the departure time inputted from the car-navigation system 52 is transmitted to the server computer 3 by the power line communication. Then, in a step S404, the server computer 3 transmits the information about the destination and the departure time to the information center 7 through the communication network 12. Therefore, the remote module 70 in the information center 7 retrieves the information from the plug-in vehicle 4 via the power line communication, the server computer 3 and the communication network 12. Step S405 is the same as the step S304. Then, in a step S406, the remote module 70 sends back the required charge amount Ctar to the server computer 3.

In a step S407, the server computer 3 transmits the required charge amount Ctar to the charge controller 5 by the power line communication. Step S408 is the same as the step S104. Then, in a step S409, the charge controller 5 sends the present charge amount Cdet to the server computer 3 via the power line communication. In a step S410, the server computer 3 calculates the estimated time T1 based on a difference between the required charge amount Ctar retrieved from the information center 7 and the present charge amount Cdet detected by the charge amount detecting device 51. The estimated time T1 is estimated necessary to charge the battery 42 to the required charge amount Ctar. The estimated time T1 can be calculated by taking several information into consideration. For example, the estimated time T1 may be calculated based on a charge current, a charge voltage, and a capacity of a battery charger circuit of the battery 42. Steps S411-S415 are the same as the steps S207-S211.

According to the embodiment, it is possible to send the estimated time T1 and the charge completion information T2 to the terminal 6. In this embodiment, the information center 7 includes the calculating module. The server computer 3 includes a part of the informing module. The charge controller 5 on the plug-in vehicle 4 contains a part of the informing module. It is possible to reduce processing load on the components on the plug-in vehicle 4.

### Fifth Embodiment

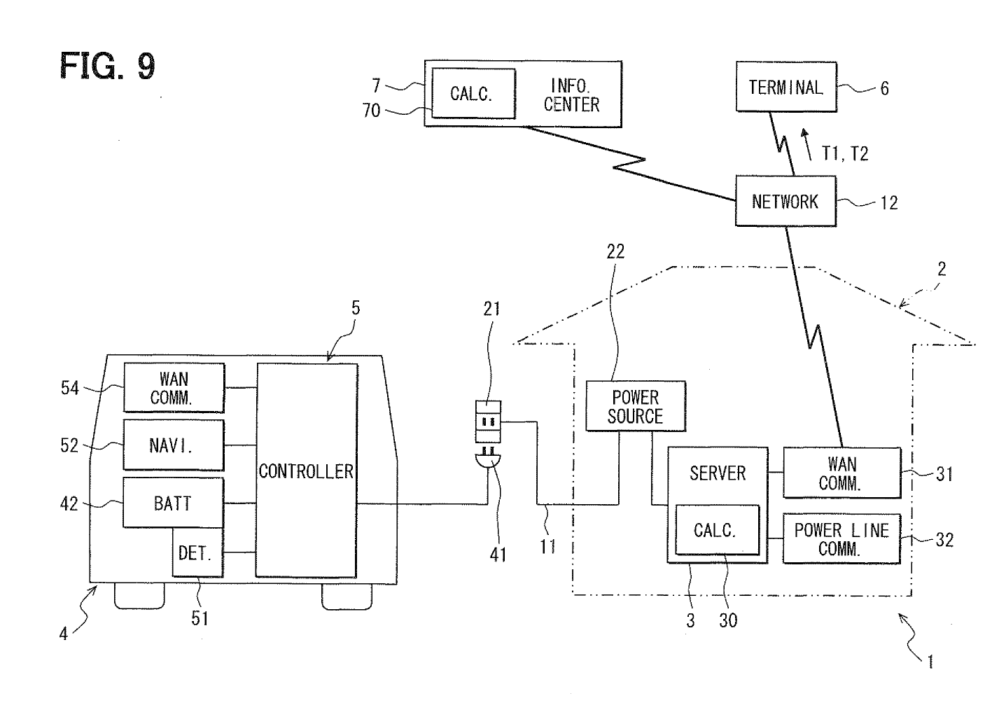

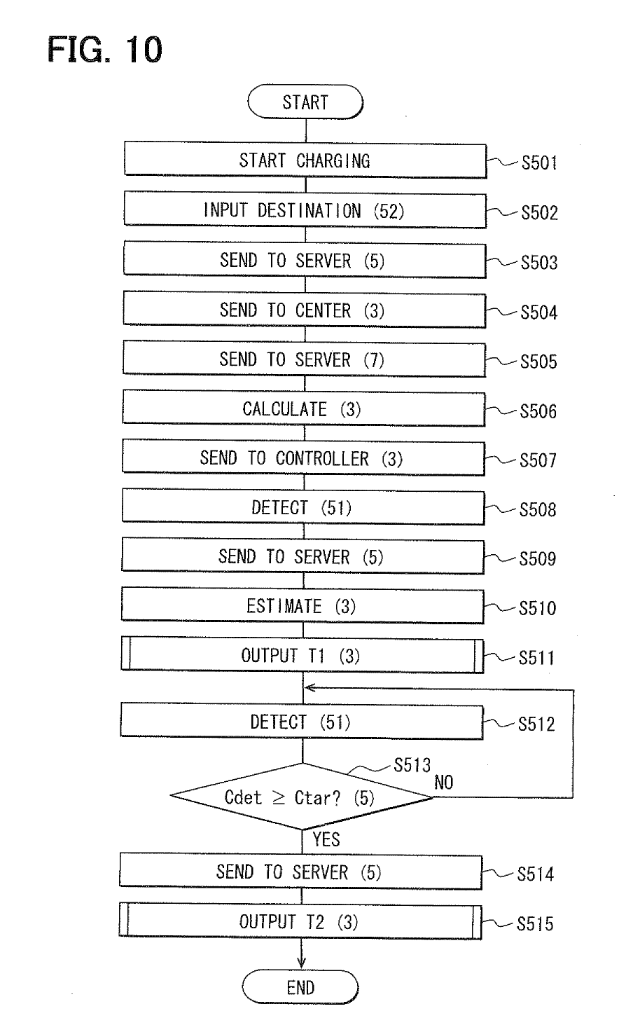

FIG. 9 shows a block diagram of the fifth embodiment. In this embodiment, the server computer 3 on the charging station 2 includes a calculating module 30 for calculating the required charge amount Ctar. FIG. 10 is a flowchart showing operation of the plug-in vehicle remote monitoring system 1. Steps S501-S504 and S507-S515 are the same as the steps S401-S404 and S407-S415, respectively.

In a step S503, the information about the destination and the departure time inputted from the car-navigation system 52 is transmitted to the server computer 3 by the power line communication. In a step S504, the information about the destination and the departure time is transmitted to the information center 7 from the server computer 3 by the network communication device 31 via the communication network 12.

According to the embodiment, it is possible to send the estimated time T1 and the charge completion information T2 to the terminal 6. In this embodiment, the server computer 3 includes the calculating module and a part of the informing module. The charge controller 5 on the plug-in vehicle 4 contains a part of the informing module. It is possible to reduce processing load on the components on the plug-in vehicle 4.

### Other Embodiment

The components and modules in the above embodiments may be provided by software, hardware or combination of them.

Although the present invention has been fully described in connection with the preferred embodiments thereof with reference to the accompanying drawings, it is to be noted that various changes and modifications will become apparent to those skilled in the art. Such changes and modifications are to be understood as being within the scope of the present invention as defined by the appended claims.

What is claimed is:

1. A remote monitoring system for a plug-in vehicle, which sends information relating to charging operation in the plug-in vehicle to a terminal, the system comprising:
a detecting module which detects a present charge amount in a battery of the plug-in vehicle;
a calculating module which calculates a required charge amount which is necessary for a trip planned for the plug-in vehicle; and
an informing module which generates charge information relating to completion of charging based on the present charge amount detected by the detecting module and the required charge amount calculated by the calculating module, and sends the charge information to the terminal via a communication system.

2. The remote monitoring system for a plug-in vehicle in claim 1, wherein
the communication system includes:
a WAN communication device on the plug-in vehicle, which is connectable with a communication network, and wherein
the calculating module includes:
a car-navigation system on the plug-in vehicle, which receives input of a destination and calculates a route to the destination, and a vehicle calculating module on the plug-in vehicle, which calculates the required charge amount necessary for a one way trip to the destination from the charging station or the required charge amount necessary for a round trip to the destination from the charging station, and wherein
the informing module includes:
a charge controller which generates charge completion information as the charge information in response to a time when the present charge amount reaches to the required charge amount, in the charging operation to the battery by connecting a station side connector and a vehicle side connector, and which sends the charge completion information to the terminal via the WAN communication device.

3. The remote monitoring system for a plug-in vehicle in claim 1, wherein
the communication system includes:
a WAN communication device on the plug-in vehicle, connectable with an communication network, and wherein
the calculating module includes:
a car-navigation system on the plug-in vehicle, which receives input of a destination and calculates a route to the destination; and
a vehicle calculating module on the plug-in vehicle, which calculates the required charge amount necessary for a one way trip to the destination from the charging station or the required charge amount necessary for a round trip to the destination from the charging station, and wherein
the informing module includes:
a charge controller which generates an estimated time as the charge information, the estimated time being estimated necessary to charge the battery to the required charge amount by taking the present charge amount into consideration, in the charging operation to the battery by connecting a station side connector and a vehicle side connector, and which sends the estimated time to the terminal via the WAN communication device.

4. The remote monitoring system for a plug-in vehicle in claim 1, wherein
the communication system includes:
a vehicle side power line communication device on the plug-in vehicle;
a station side power line communication device which communicates with the vehicle side power line communication device through a power line which connects a station side connector and a vehicle side connector;
a server computer on the charging station, which is connected with the station side power line communication device; and
a network communication device on the charging station, which is connected with the server computer and is connectable with a communication network, and wherein
the calculating module includes:
a car-navigation system on the plug-in vehicle, which receives input of a destination and calculates a route to the destination; and
a vehicle calculating module on the plug-in vehicle, which calculates the required charge amount necessary for a one way trip to the destination from the charging station or the required charge amount necessary for a round trip to the destination from the charging station, and wherein
the informing module includes:
a charge controller on the plug-in vehicle, which generates charge completion information as the charge information in response to a time when the present charge amount reaches to the required charge amount, in the charging operation to the battery during a power line communication between the station side power line communication device and the vehicle side power line communication device is enabled by connecting the station side connector and the vehicle side connector, and which sends the charge completion information to the terminal via the power line and the communication network.

5. The remote monitoring system for a plug-in vehicle in claim 1, wherein
the communication system includes:
a vehicle side power line communication device on the plug-in vehicle;
a station side power line communication device which communicates with the vehicle side power line communication device through a power line which connects a station side connector and a vehicle side connector;
a server computer on the charging station, which is connected with the station side power line communication device; and
a network communication device on the charging station, which is connected with the server computer and is connectable with a communication network, and wherein
the calculating module includes:
a car-navigation system on the plug-in vehicle, which receives input of a destination and calculates a route to the destination; and
a vehicle calculating module on the plug-in vehicle, which calculates the required charge amount necessary for a one way trip to the destination from the charging station or the required charge amount necessary for a round trip to the destination from the charging station, and wherein
the informing module includes:
a charge controller on the plug-in vehicle, which generates an estimated time as the charge information, the estimated time being estimated necessary to charge the battery to the required charge amount by taking the present charge amount into consideration, in the charging operation to the battery during a power line communication between the station side power line communication device and the vehicle side power line communication device is enabled by connecting the station side connector and the vehicle side connector, and which sends the estimated time to the terminal via the power line and the communication network.

6. The remote monitoring system for a plug-in vehicle in claim 2, wherein
the vehicle calculating module calculates the required charge amount based on information including a route from the charging station to the destination, a road inclination from the charging station to the destination, a departure time from the charging station to the destination, and traffic information stored in the car-navigation system.

7. The remote monitoring system for a plug-in vehicle in claim 1, wherein
the communication system includes a WAN communication device on the plug-in vehicle, which is connectable with a communication network to which an information center which manages information including a location of the plug-in vehicle, and wherein
the calculating module includes:
an input device on the plug-in vehicle, which receives input of a destination and a departure time, and a remote module on the information center, which retrieves information including the destination and the departure time via the WAN communication device and the communication network, and which calculates the required charge amount necessary for a one way trip to the destination from the charging station or the required charge amount necessary for a round trip to the destination from the charging station based on the retrieved information and information including route information and/or traffic information stored in the information center, in the charging operation to the battery by connecting a station side connector and a vehicle side connector, and wherein
the informing module includes:
a charge controller on the plug-in vehicle, which retrieves the required charge amount from the remote module in the information center via the communication system, which generates charge completion information as the charge information in response to a time when the present charge amount reaches to the required charge amount, and which sends the charge completion information to the terminal via the WAN communication device.

8. The remote monitoring system for a plug-in vehicle in claim 1, wherein
the communication system includes a WAN communication device on the plug-in vehicle, which is connectable with a communication network to which an information center which manages information including a location of the plug-in vehicle is connected, and wherein
the calculating module includes:
an input device on the plug-in vehicle, which receives input of a destination and a departure time, and a remote module on the information center, which retrieves information including the destination and the departure time via the WAN communication device and the communication network, and which calculates the required charge amount necessary for a one way trip to the destination from the charging station or the required charge amount necessary for a round trip to the destination from the charging station based on the retrieved information and information including route information and/or traffic information stored in the information center, in the charging operation to the battery by connecting a station side connector and a vehicle side connector, and wherein
the informing module includes:
a charge controller on the plug-in vehicle, which retrieves the required charge amount from the remote module in the information center via the communication system, which generates an estimated time as the charge information, the estimated time being estimated necessary to charge the battery to the required charge amount by taking the present charge amount into consideration, and which sends the estimated time to the terminal via the communication network.

9. The remote monitoring system for a plug-in vehicle in claim 1, wherein
the communication system includes:
a vehicle side power line communication device on the plug-in vehicle;
a station side power line communication device which communicates with the vehicle side power line communication device through a power line which connects a station side connector and a vehicle side connector;
a server computer on the charging station, which is connected with the station side power line communication device; and
a network communication device on the charging station, which is connected with the server computer and is connectable with a communication network to which an information center which manages information including a location of the plug-in vehicle is connected, and wherein
the calculating module includes:
an input device on the plug-in vehicle, which receives input of a destination and a departure time; and
a remote module on the information center, which retrieves information including the destination and the departure time via the communication system, and which calculates the required charge amount necessary for a one way trip to the destination from the charging station or the required charge amount necessary for a round trip to the destination from the charging station based on the retrieved information and information including route information and/or traffic information stored in the information center, in the charging operation to the battery during a power line communication between the station side power line communication device and the vehicle side power line communication device is enabled by connecting a station side connector and a vehicle side connector, and wherein
the informing module includes:
a charge controller on the plug-in vehicle, which retrieves the required charge amount from the remote module in the information center via the communication system, which generates charge completion information as the charge information in response to a time when the present charge amount reaches to the required charge amount, and which sends a signal to the server computer via the power line communication; and
a server informing module on the server computer, which sends the charge completion information to the terminal via the network communication device and the communication network.

10. The remote monitoring system for a plug-in vehicle in claim 1, wherein
the communication system includes:
a vehicle side power line communication device on the plug-in vehicle;
a station side power line communication device which communicates with the vehicle side power line communication device through a power line which connects a station side connector and a vehicle side connector;
a server computer on the charging station, which is connected with the station side power line communication device; and
a network communication device on the charging station, which is connected with the server computer and is connectable with a communication network to which an information center which manages information including a location of the plug-in vehicle is connected, and wherein
the calculating module includes:
an input device on the plug-in vehicle, which receives input of a destination and a departure time; and
a remote module on the information center, which retrieves information including the destination and the departure time via the communication system, and which calculates the required charge amount necessary for a one way trip to the destination from the charging station or the required charge amount necessary for a round trip to the destination from the charging station based on the retrieved information and information including route information and/or traffic information stored in the information center, in the charging operation to the battery during a power line communication between the station side power line communication device and the vehicle side power line communication device is enabled by connecting a station side connector and a vehicle side connector, and wherein
the informing module includes:
a server informing module on the server computer, which retrieves the required charge amount from the remote module in the information center via the communication system, which retrieves the present charge amount from the detecting module via the power line communication, which generates an estimated time as the charge information, the estimated time being estimated necessary to charge the battery to the required charge amount by taking the present charge amount into consideration, and which sends the estimated time to the terminal via the network communication device and the communication network.

11. The remote monitoring system for a plug-in vehicle in claim 1, wherein
the communication system includes:
a vehicle side power line communication device on the plug-in vehicle;
a station side power line communication device which communicates with the vehicle side power line communication device through a power line which connects a station side connector and a vehicle side connector;
a server computer on the charging station, which is connected with the station side power line communication device; and
a network communication device on the charging station, which is connected with the server computer and is connectable with a communication network to which an information center which manages information including a location of the plug-in vehicle is connected, and wherein
the calculating module includes:
an input device on the plug-in vehicle, which receives input of a destination and a departure time;
a remote module on the information center, which retrieves information including the destination and the departure time via the communication system, and which sends information including route information and/or traffic information stored in the information center to the server computer, in the charging operation to the battery during a power line communication between the station side power line communication device and the vehicle side power line communication device is enabled by connecting a station side connector and a vehicle side connector; and
a server calculating module on the server computer, which calculates the required charge amount necessary for a one way trip to the destination from the charging station or the required charge amount necessary for a round trip to the destination from the charging station based on the retrieved information including route information and/or traffic information retrieved from the remote module in the information center, and which sends the required charge amount via the power line communication, and wherein
the informing module includes:
a charge controller on the plug-in vehicle, which retrieves the required charge amount from the server module, which generates charge completion information as the charge information in response to a time when the present charge amount reaches to the required charge amount, and which sends a signal to the server computer via the power line communication; and
a server informing module on the server computer, which sends the charge completion information to the terminal via the network communication device and the communication network.

12. The remote monitoring system for a plug-in vehicle in claim 1, wherein
the communication system includes:
a vehicle side power line communication device on the plug-in vehicle;
a station side power line communication device which communicates with the vehicle side power line communication device through a power line which connects a station side connector and a vehicle side connector;
a server computer on the charging station, which is connected with the station side power line communication device; and
a network communication device on the charging station, which is connected with the server computer and is connectable with a communication network to which an information center which manages information including a location of the plug-in vehicle is connected, and wherein
the calculating module includes:
an input device on the plug-in vehicle, which receives input of a destination and a departure time; and
a remote module on the information center, which retrieves information including the destination and the departure time via the communication system, and which sends information including route information and/or traffic information stored in the information center to the server computer, in the charging operation to the battery during a power line communication between the station side power line communication device and the vehicle side power line communication device is enabled by connecting a station side connector and a vehicle side connector; and
a server calculating module on the server computer, which calculates the required charge amount necessary for a one way trip to the destination from the charging station or the required charge amount necessary for a round trip to the destination from the charging station based on the retrieved information including route information and/or traffic information retrieved from the remote module in the information center, and wherein
the informing module includes:
a server informing module on the server computer, which retrieves the present charge amount from the detecting module via the power line communication, which generates an estimated time as the charge information, the estimated time being estimated necessary to charge the battery to the required charge amount by taking the present charge amount into consideration, and which sends the estimated time to the terminal via the network communication device and the communication network.

13. The remote monitoring system for a plug-in vehicle in claim 7, wherein
the calculating module calculates the required charge amount based on information including a route from the charging station to the destination, traffic information from the charging station to the destination, and a road inclination from the charging station to the destination.
